(19) United States
(12) Patent Application Publication
(10) Pub. No.: US 2025/0371644 A1
(43) Pub. Date: Dec. 4, 2025

(54) SYSTEM AND METHOD FOR IDENTIFYING MEDIA CONTENT

(71) Applicant: Innovasoft Tech Holdings Ltd, Nicosia (CY)

(72) Inventors: Jordan Pleet, Montreal (CA); Olivier Hillman Beauchesne, Montreal (CA); Bertrand Chapleau, Montreal (CA); Jonathan Alexander Garry, Montreal (CA); Peter Dimitropoulos, Montreal (CA)

(21) Appl. No.: 19/219,071

(22) Filed: May 27, 2025

Related U.S. Application Data
(60) Provisional application No. 63/652,367, filed on May 28, 2024.

(51) Int. Cl. G06T 1/00; G06T 7/11; G06V 30/10

(52) U.S. Cl. CPC G06T 1/0021; G06T 7/11; G06V 30/10; G06T 2207/20132

(57) ABSTRACT

Systems, methods, and computer-readable storage media for identifying media content, and more specifically to automatically detecting and tagging media content (such as speech, watermarks, predetermined actions) and flagging portions of content which may require additional moderation. To detect watermarks, a system can receive a video, then sample frames from that video. The system can then average the sampled frames together, resulting in an averaged frame, and execute a text detection model on the averaged frame, resulting in a text detection model output. The system can then identify, based on the text detection model output, a watermark found across the plurality of frames.

### CROSS-REFERENCE TO RELATED APPLICATIONS

The present patent application claims priority benefit to U.S. Provisional Patent Application No. 63/652,367, filed May 28, 2024, the entire content of which is incorporated herein by reference.

### BACKGROUND

### 1. Technical Field

The present disclosure relates to identifying media content, and more specifically to automatically detecting and tagging media content (such as speech, watermarks, predetermined actions) and flagging portions of content which may require additional moderation.

### 2. Introduction

Online platforms which allow users to post media, such as social networks and video sharing sites, have policies regarding posting of copyrighted and/or otherwise prohibited content. To enforce these policies, the platforms must engage in some form of content moderation. However, because of the amount of content being uploaded, these online platforms use automation to perform at least a preliminary identification of the content of uploaded media.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a video, the video comprising a plurality of frames; sampling frames from the plurality of frames via at least one processor, resulting in sampled frames and unsampled frames; averaging, via the at least one processor, the sampled frames together, resulting in an averaged frame; executing, via the at least one processor, a text detection model on the averaged frame, resulting in a text detection model output; and identifying, via the at least one processor based on the text detection model output, a watermark found across the plurality of frames.

A system configured to perform the concepts disclosed herein can include: at least one processor; and a non-tangible computer-readable storage medium having instructions stored which, when executed by the at least one processor, cause the at least one processor to perform operations comprising: receiving a video, the video comprising a plurality of frames; sampling frames from the plurality of frames, resulting in sampled frames and unsampled frames; averaging the sampled frames together, resulting in an averaged frame; executing a text detection model on the averaged frame, resulting in a text detection model output; and identifying, based on the text detection model output, a watermark found across the plurality of frames.

A non-transitory computer-readable storage medium configured as disclosed herein can have instructions stored which, when executed by at least one processor, cause the at least one processor to perform operations which include: receiving a video, the video comprising a plurality of frames; sampling frames from the plurality of frames, resulting in sampled frames and unsampled frames; averaging the sampled frames together, resulting in an averaged frame; executing a text detection model on the averaged frame, resulting in a text detection model output; and identifying, based on the text detection model output, a watermark found across the plurality of frames.

### BRIEF DESCRIPTION OF THE DRAWINGS

FIG. 1 illustrates an example system embodiment;

FIG. 2 illustrates an example of processing content using a pipeline handler;

FIG. 3 illustrates an example of watermark detection using the disclosed system;

FIG. 4 illustrates an example method embodiment; and

FIG. 5 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Online platforms where users can post media, such as (but not limited to) FACEBOOK, YOUTUBE, RUMBLE, TWITTER/X, and LINKEDIN have guidelines regarding what types of content can and cannot be shared. If, for example, one were to post content which is copyrighted or otherwise against the platform's guidelines, that content may be subject to removal. In order to identify what content is being uploaded, the platform must perform content identification and moderation.

Systems configured as disclosed herein perform content identification on uploaded media using particular methods, which allow the system to search for particular types of content according to user preferences. The identified content can then be labelled and inserted into the media for future searching and navigation, and if necessary, can be forwarded to a content moderator for review.

Non-limiting types of media which can be uploaded and identified can include images, videos, audio, or combinations thereof. The system can classify the media, to determine if the content captures (or is) a video game, anime (such as hentai), and/or real life. The type of content identified within uploaded media can vary depending upon the specific needs of a user and/or based on the type of media uploaded. Non-limiting forms of content which the system disclosed herein can identify can include: text, watermarks, faces, speech, actions, location, nudity, podcast, and/or hotspot (i.e., the best place to start a show or start a video).

When new media is detected a message handler reads the media, a pipeline handler passes the job through the tagging pipelines, and the tagging results are sent back to the message handler to be saved. More specifically, the system's message handler identifies that the media is received, then passes the media through a tagging pipeline, where the tagging pipeline identifies if and where within the media specific content is located (e.g., at what location within an image a face is located, or at what time the content is located). Specific message handlers can be created per client computer, allowing the clients to meet their needs and requirements for sending jobs and receiving results; by contrast, the pipeline handler procedures are consistent for all clients in communication with the system. Tags can be inserted into the media, allowing for quickly navigating to the identified content after the pipeline process. The tagged results can then be sent back to the message handler to be saved. When no additional/unprocessed media is identified, the system can pause or otherwise wait for future media to be uploaded.

Jobs read by the message handler are passed to the pipeline handler. The pipeline handler pipes the jobs through a series of pipelines. The pipelines are parallelized (e.g., with Celery in Python) so multiple jobs can be run at the same time. After each pipeline, results are saved by the message handler. Upon receiving media, the system can determine (via the message handler or other mechanisms) the type of media uploaded (e.g., is the media an image or a video). This determination can, for example, be based on the file extension of the media, the formatting of the media, and/or based on the size of the media.

The pipeline order for identifying specific types of content and associated tags can be based on priority and requirements. If, for example, certain tag results are of higher priority (like face age estimation), those prioritized tag results can be run first and results are then available as soon as possible. Some pipelines may also need to run first because their results are prerequisites for subsequent pipelines. For instance, face detection would be prioritized so its results are available for face age estimation and face classification. Parameters for pipeline processing can be initially set by content moderation depending on their requirements. For instance, with text detection, parameters can be set to: only process watermark text, process all text throughout the media content, or process both watermark and all the text, and how frequently throughout the media content should text be detected.

The system is modular so more tagging pipelines can be easily added as future types of content are identified. That is, the types of content, and the pipelines associated with those types of content, which the system identifies can vary as needed, and can increase in the future. Normally, the first pipelines download the content if there is a Uniform Resource Locator (URL) address and try to extract frames and audio from video. The paths to the downloaded content, extracted frames, and audio can then be passed through the other pipelines. Exemplary pipelines can include: Face pipelines (including face detection, face embedding, face age classification, face age, face classification); Speech detection pipelines; Action detection; Location detection; Media classification; Podcast detection; Text Detection; Watermark detection; Nudity detection; Thumbnail scoring; and Hotspot detection.

### Face-Related Pipelines:

Face Detection—Images and frames from animations and videos are passed through a Multi-Task Cascaded Convolutional Neural Network (MTCNN) model to detect faces. The detected faces can then go through a facial expression recognition model. With results from the detection and expression models, a face quality score can be calculated. Higher face quality scores mean the face is more likely to match another high-quality face of the same person.

Face Embedding—The face detections can be passed through different possible embedders to convert the face image into a list of numbers (i.e., an embedding or a vector). Because the same person will have very similar face embeddings, a distance calculation (measuring the geometric distance between a previously captured embedding and an embedding from a current image or video) can be calculated to determine if the individual whose face is captured in the video matches one or more known individuals (or more precisely, if the captured facial embedding is within a predetermined range of previously captured embeddings).

Face Age Classification—The face embeddings can be clustered to form groups of the same faces (i.e., multiple embeddings captured from a video captured from a single individual within the video). The faces in each cluster then go through a classifier to predict if the individual whose embeddings form the cluster is 1) 25 years old or under or 2) over 25 years old.

Face Age—The highest quality face in younger clusters (25 years old or under) can be passed to 3rd party services to get more specific age estimates.

Face Classification—The face clusters are classified into an age range, gender, and ethnicity. The face embeddings are passed through the face classification model and the results of each cluster can be averaged together, weighed by the face quality.

Speech Pipeline—With audio from videos, a voice activity detection model can be run to find clear voices and then audio clips of these clear voices are passed to a speech-to-text transcription model. The output from speech detection can be used as subtitles or closed captioning for videos.

Action Detection Pipeline—There are two action detection models: one for images (which is a basic Convolutional Neural Network (CNN)) and one for sequences of images (i.e., animations and videos). Both models can be trained to detect a similar set of actions, such as walking, running, throwing a football, eating, playing basketball, sitting, sexual activities, etc. Parameters can be set for varying class score thresholds and action duration thresholds.

Location Detection Pipeline—Location detection can be based on a scene recognition dataset, with the system predicting the location at three different levels. At the highest level, the location can be predicted to be indoor or outdoor. The next highest level can be whether in nature, rural, urban, private space, public space, sporting event, vehicle, water, etc. The lowest level can predict one of a number of specific locations.

Media Classification Pipeline—The media classification pipeline determines if the content is a video game, anime (e.g., hentai), or real life.

Podcast Detection Pipeline—Using the results of speech detection, face detection, and action detection, videos can be tagged as podcast if there is speech most of the time or “podcast” is spoken, faces remain nearly in the same place, and/or there is no action detected.

Text Detection—Written words within media can be detected and transcribed using two text detection models—a detection model and a recognition model. The detection model can detect where text is within the media and the recognition model gathers the detected text area to form words. The two models can each be run once for an image.

For animations and videos, the two text detection models can be run in two ways: 1) on frames every few seconds (i.e., sampling frames) to find text spread throughout the media. These sampled frames can be sampled periodically, randomly, or based on detecting predetermined differences in the frames; or 2) on a sample of frames that are averaged into one image to find text-based watermarks that do not change position over time.

Because text can be in any part of the image (or frame or average frame), and certain text detection models compress the image, losing details, different parts of the image are passed separately through the model to maintain details and aspect ratios. There are several possible crops, like padded bottom, padded top, padded left, padded right, top-left, top-right, bottom-left, bottom-right, or custom crops for specific cases.

Consider the following example of watermark detection: To detect a stationary watermark, sampled frames can be averaged at the same coordinates, with the expectation that changes in pixels caused by movement will be merged and only static portions of the video or animation, like watermarks, will remain clear. The single averaged image is passed through the multiple (detection and recognition) models and crops. An inverted version of the sampled image can also be processed as it can increase the readability of white text on a darker background.

Words extracted from the text detection system can be deduplicated and concatenated into a single string per video or image. Several possible fuzzy matching algorithms can be used to match a list of banned words (or any list of words of interest). A configurable quantity of misspellings can be allowed as text extraction is not always accurate (e.g., watermarks are usually formatted as stylized text or within additional graphic elements). For example, a threshold of three misspellings can be used. Approximate matches can then be collected and shared with moderators for manual review.

The text and/or watermarks detected can be used by the system to remove copyrighted or otherwise infringing content, or send take-down notices to those infringing on content. For example, the system may detect videos that have a brand's watermark, but failed to mention the brand in the title or description of the video. Likewise, the system can use the text and/or watermarks detected to detect unacceptable content, content from brands which have not authorized the platform to publish their content, etc., and the system can block/flag new uploads having those watermarks. The system can also back scan previously uploaded content to identify any previously uploaded content which should have been blocked or otherwise removed.

Nudity Detection Pipeline—Content is passed through a nudity detection model to determine if and where nudity exists.

Thumbnail Scoring Pipeline—Thumbnails are important to promote and market videos. Frames can be scored by a quality metric, the presence of faces, and if actions were detected. Videos can be split into sections (usually sixteen, though that number can vary depending on the length of the video and user preferences) and the best scoring frames in each section are provided as possible thumbnails.

Hotspot Detection Pipeline—Similar to thumbnails, a hotspot is the likely best place to show or start a video. Often, the highest scoring thumbnail score can be considered the hotspot.

When one or more of these pipelines identifies content, the system can add a tag (e.g., metadata) identifying where the identified content is located within the analyzed media. If, for example, the systems detects walking at a specific moment within the video, a tag indicating when that action occurs can be recorded in the video at that specific moment, such that the action can be readily searched for and identified.

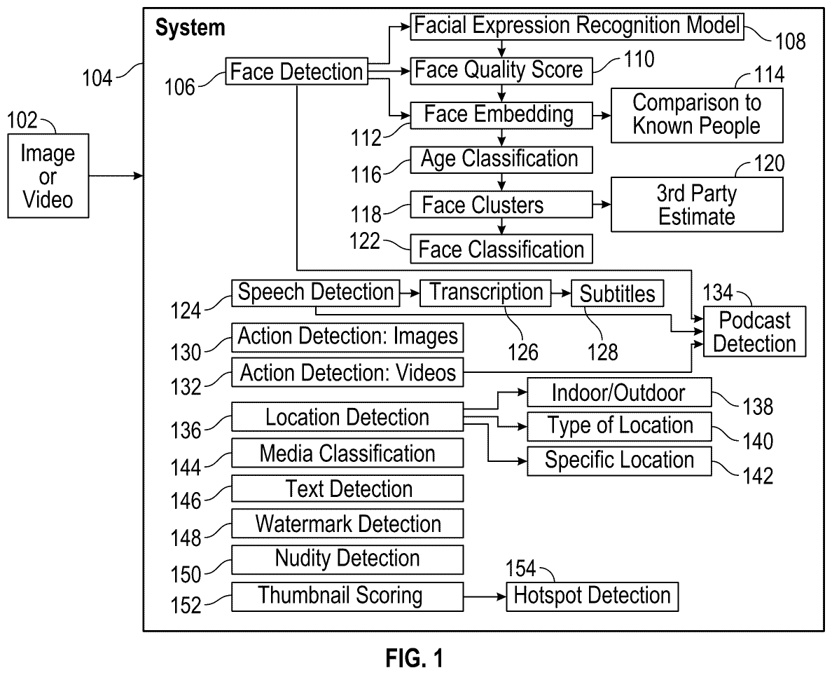

FIG. 1 illustrates an example system embodiment. In this example, the system 104 receives media 102 (an image or video). The system 104 can then initiate one or more pipelines to detect content within the media 102, which can be executed sequentially or in parallel, depending on the type of content being detected. As illustrated, some pipelines or results rely on previously identified content.

The face detection 106 pipeline can be initiated, with the system identifying any faces within the media 102 (images or video). The detected faces can then be used as inputs to a facial expression recognition model 108, which identifies expressions on the detected faces (such as happy, sad, tired, bored, etc.). The detected expressions from the facial expression recognition model 108 and/or the detected faces from the initial face detection 106 are then used to generate a face quality score 110. The face quality score 110, where a higher face quality score means the face is more likely to match another high-quality face of the same person, and thereby allow the system to identify who is in a given image or video. The detected faces from the initial face detection 106 can then be converted to a face embedding 112. In some configurations, only those detected faces with high face quality scores 110 are converted to face embeddings 112. The resulting embeddings can then be compared to known people 114 and, if the identity of those appearing in the media 102 can be determined, a tag for the media 102 identifying the individual can be added to the media 102.

The face embeddings can also be used for age classification 116, forming face clusters 118 of detected faces belonging to an individual and using a classifier to predict if the individual is twenty-five years old or under twenty-five years old. Those predicted to be under twenty-five can be sent to a third party estimator 120 for additional verification. The face clusters 118 can also undergo face classification 122, where the face clusters are classified into age range, gender, ethnicity, etc. More specifically, the face clusters can be passed through a face classification model, with the results of each cluster being averaged together and weighed by the face quality scores 110.

The speech detection 124 pipeline can detect speech within video media, resulting in a transcription 126 of the video. That transcription 126 can then be added to the media 102 with timestamps corresponding to when the speech was found in the video, and subsequently used as subtitles 128 (aka closed captioning) for those watching the video.

Distinct pipelines can be generated for action detection of images 130 and videos 132. The action detection model for detection of actions within images 130 can use a CNN, while the action detection model for detection of actions within video 132 can use a model for sequences of images.

A podcast detection 134 pipeline can use the outputs of the face detection 106, the speech detection 124, and the action detection for videos 132 to determine if a given video is in fact a podcast, as opposed to other types of videos.

A location detection 136 pipeline can predict the location of the media 102 at different levels. At a high level, the detection can identify if the media 102 is indoor or outdoor 138; at a medium level if the media 102 is in a given type of location 140 (e.g., is it at a beach, in nature, urban, private, public, etc.); and at a lower level if the media 102 is at a specific (i.e., known) location 142 (e.g., the Golden Gate bridge, the White House, Central Park, etc.).

A media classification 144 pipeline can determine if the media 102 is a video game, anime (e.g., hentai), or if the media 102 depicts real life.

A text detection 146 pipeline can identify text in an image, or within specific frames of a video. For images, one or more text detection models is run on the full image and selected crops (top-left/right, bottom left/right, top and bottom) of the resulting cropped images.

For video, the text detection 146 pipeline can be used on sampled frames, where full detection runs selected text detection models on selected crops of each of the sampled frames to find dynamically changing text.

In addition, for video a watermark detection 148 pipeline can be used to find static text, where all of the sampled frames are first averaged to highlight text in the same position throughout. One or more text detection models can then be run on selected crops (or inversions) of the single average image, resulting in detected watermarks (if available). After text detection for all content, the list of detected words can be queried against lists of words to find if there are any fuzzy matches to be reviewed by a moderation team.

A nudity detection 150 pipeline can identify, in both images and video, nudity within the media 102.

In addition, a thumbnail scoring 152 pipeline can score frames within a video by a quality metric, the presence of faces, and/or if actions are detected. Videos can then be split into sections based on the frame quality scores, and the best scoring frames can be provided to a user as possible thumbnails. If desired, a hotspot detection 154 pipeline can identify the best place to show or start a video. In some configurations, the hotspot can be the best scoring thumbnail from the thumbnail scoring 152 pipeline.

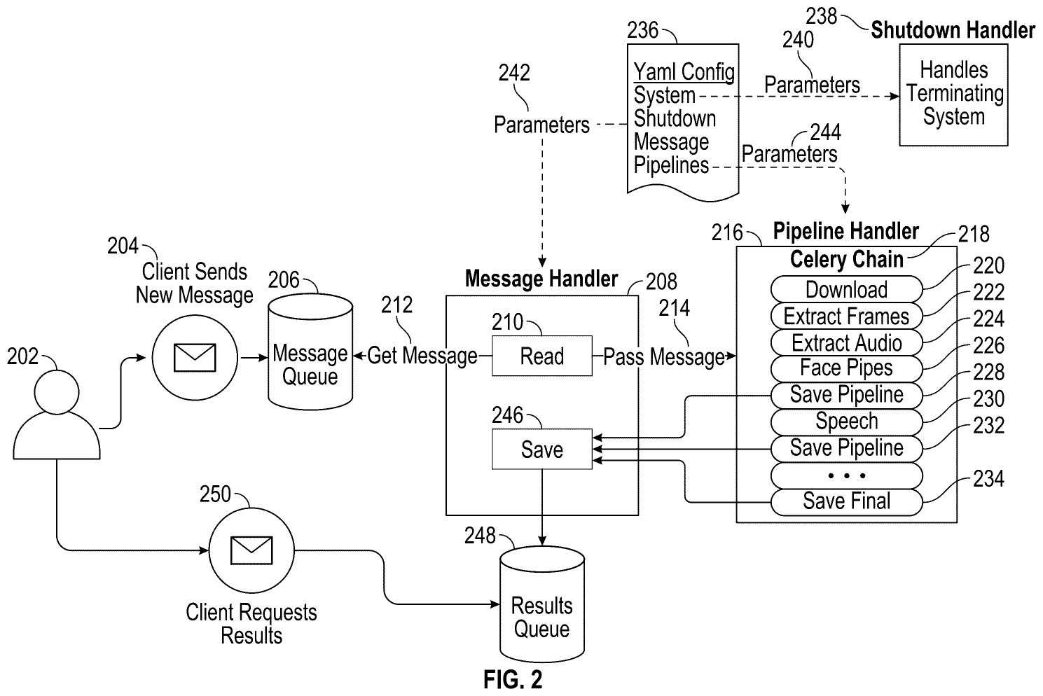

FIG. 2 illustrates an example of processing content using a pipeline handler 216. In this example a client 202 (which may be a human user, or another computer system) sends a new message 204 to a message queue 206, the message indicating that a piece of media should be reviewed. The media can be newly introduced to the system, or the media may have been stored within the platform for some time and need to be reviewed. A read module 210 of a message handler 208 sends a get message 212 to the message queue 206, and passes the message 214 to a pipeline handler 216. The pipeline handler 216 initiates pipelines 220-234 using a Celery chain 218 (or other asynchronous task queue or job queue). Non-limiting examples of the pipelines 220-234 can include downloading 220 the media, extracting frames 222, extracting audio 224, performing facial detection (face pipes 226), saving pipeline data 228 (i.e., saving the facial detection information), speech detection 230, saving the pipeline data 232 (i.e., saving the speech data), and saving the final data 234 (i.e., saving any additional pipeline data that is generated or identified).

The message handler 208 and the pipeline handler receive respective parameters 242, 244 from a configuration file 236 (in this example, it is a Yet Another Markup Language (YAML) configuration file), which stores the parameters 244 for how the pipeline handler 216 operates, the parameters 242 for how the message handler 208 operates, and the parameters 240 for a shutdown handler 238, which handles terminating the system when no additional messages are in the message queue 206.

The output of the pipelines 220-234 can be sent from the pipeline handler 216 to a save 246 module of the message handler 208, and the message handler 208 can store the results in a results queue 248. The client 202 can then request results 250 from the system with regard to a specific job or piece of media, and those results can be retrieved from the results queue.

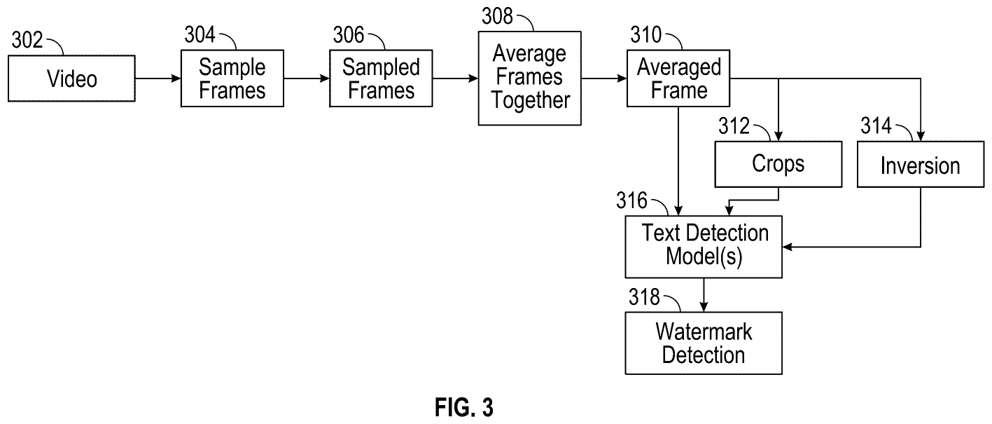

FIG. 3 illustrates an example of watermark detection using the disclosed system. In this example, the system receives a video 302 and samples the frames 304. This sampling can be at a defined interval (e.g., every five seconds, every eight frames, etc.), or can vary based on changes in the content of the frames (e.g., upon detecting a certain percentage change in the pixels from a first frame to a subsequent frame, the subsequent frame is sampled). The resulting sampled frames 306 are averaged together 308, resulting in a single averaged frame 310. This averaged frame 310 can be cropped in various ways (e.g., cutting off the top, bottom, and/or sides; adding pixels to the top, bottom, and/or sides; or a combination of cutting portions of the frames and adding portions), resulting in cropped average images 312. In addition, the averaged frame 310 can be inverted 314. In some combinations, the cropped average images 312 can also be inverted 314. The resulting cropped images 312, the inverted images 314, and the original average frame 310 can then be used as inputs to a text detection model 316 (or models), which can detect 318 if there was identifiable text across all of the frames within the video (i.e., a watermark).

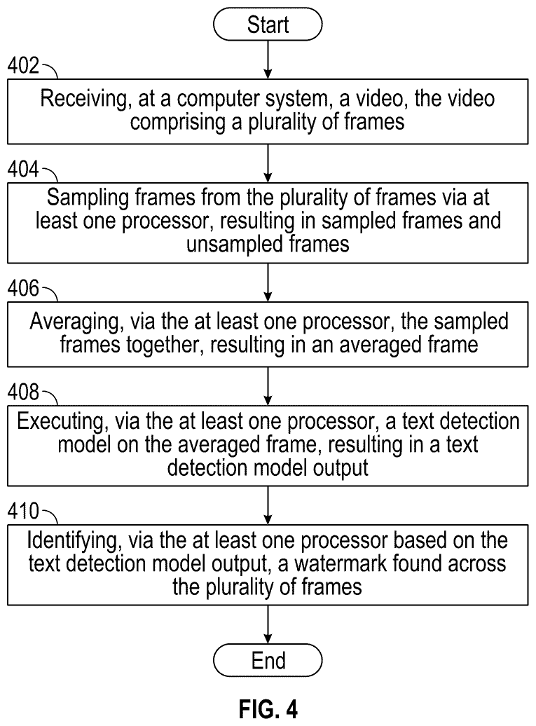

FIG. 4 illustrates an example method embodiment. The method can, for example, be performed by a system configured to practice the method. As illustrated, the method can include receiving, at a computer system, a video, the video comprising a plurality of frames (402) and sampling frames from the plurality of frames via at least one processor, resulting in sampled frames and unsampled frames (404). The method continues by averaging, via the at least one processor, the sampled frames together, resulting in an averaged frame (406), and executing, via the at least one processor, a text detection model on the averaged frame, resulting in a text detection model output (408). The method can then include identifying, via the at least one processor based on the text detection model output, a watermark found across the plurality of frames (410).

In some configurations, the illustrated method can further include: generating, via the at least one processor using the averaged frame, at least one modified frame; and executing, via the at least one processor, the text detection model on each cropped frame in the at least one modified frame, resulting in at least one modified text detection model output, wherein the identifying of the watermark is further based on the at least one modified text detection model output. In some such configurations, the at least one modified frame can include adding at least one pixel to the averaged frame, resulting in at least one of: a padded bottom, a padded top, a padded left, a padded right, a padded top-left, a padded top-right, a padded bottom-left, and a padded bottom-right. Likewise, in some such configurations, the at least one modified frame can include removing at least one pixel from the averaged frame, resulting in at least one of: a cropped bottom, a cropped top, a cropped left, a cropped right, a cropped top-left, a cropped top-right, a cropped bottom-left, and a cropped bottom-right. In still other such configurations, the at least one modified frame can include removing at least one pixel from a first side of the averaged frame and adding at least one pixel to a second side of the averaged frame.

In some configurations, the illustrated method can further include: generating, via the at least one processor using the averaged frame, at least one inverted frame; and executing the text detection model on the at least one inverted frame, resulting in at least one inverted text detection model output, wherein the identifying of the watermark is further based on the at least one inverted text detection model output.

In some configurations, the illustrated method can further include: comparing, via the at least one processor, the watermark to known watermarks belonging to previously identified brands, resulting in a comparison; and removing, via the at least one processor, the video from the computer system based on the comparison.

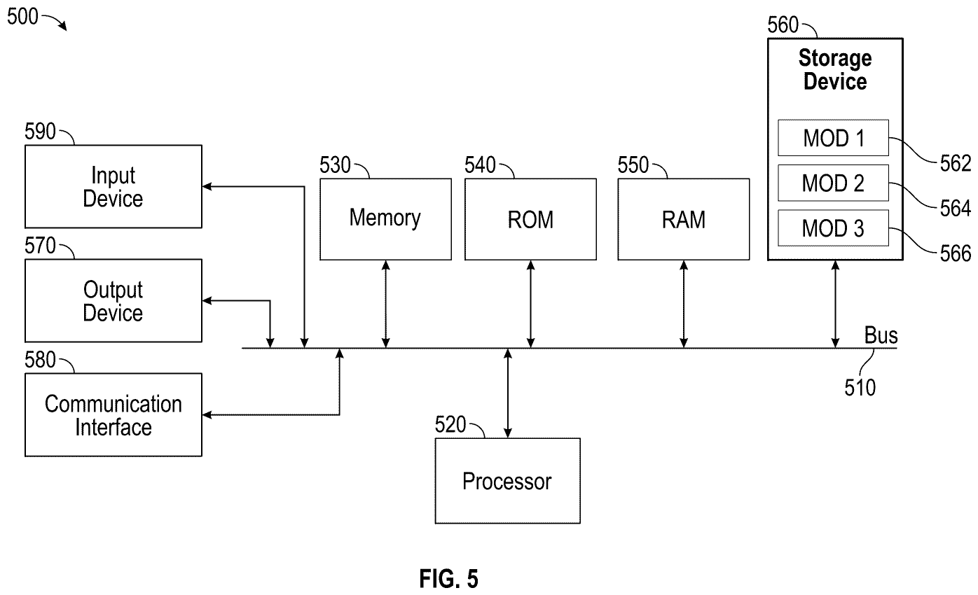

With reference to FIG. 5, an exemplary system includes a computing device 500 (such as a general-purpose computing device), including a processing unit (CPU or processor) 520 and a system bus 510 that couples various system components including the system memory 530 such as read-only memory (ROM) 540 and random access memory (RAM) 550 to the processor 520. The computing device 500 can include a cache of high-speed memory connected directly with, in close proximity to, or integrated as part of the processor 520. The computing device 500 copies data from the system memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The system memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general-purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in memory ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, system bus 510, output device 570 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 500 is a small, handheld computing device, a desktop computer, or a computer server.

Although the exemplary embodiment described herein employs the storage device 560 (such as a hard disk), other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system, a video, the video comprising a plurality of frames; sampling frames from the plurality of frames via at least one processor, resulting in sampled frames and unsampled frames; averaging, via the at least one processor, the sampled frames together, resulting in an averaged frame; executing, via the at least one processor, a text detection model on the averaged frame, resulting in a text detection model output; and identifying, via the at least one processor based on the text detection model output, a watermark found across the plurality of frames.

The method of any preceding clause, further comprising: generating, via the at least one processor using the averaged frame, at least one modified frame; and executing, via the at least one processor, the text detection model on each cropped frame in the at least one modified frame, resulting in at least one modified text detection model output, wherein the identifying of the watermark is further based on the at least one modified text detection model output.

The method of any preceding clause, wherein the at least one modified frame comprises adding at least one pixel to the averaged frame, resulting in at least one of: a padded bottom, a padded top, a padded left, a padded right, a padded top-left, a padded top-right, a padded bottom-left, and a padded bottom-right.

The method of any preceding clause, wherein the at least one modified frame comprises removing at least one pixel from the averaged frame, resulting in at least one of: a cropped bottom, a cropped top, a cropped left, a cropped right, a cropped top-left, a cropped top-right, a cropped bottom-left, and a cropped bottom-right.

The method of any preceding clause, wherein the at least one modified frame comprises removing at least one pixel from a first side of the averaged frame and adding at least one pixel to a second side of the averaged frame.

The method of any preceding clause, further comprising: generating, via the at least one processor using the averaged frame, at least one inverted frame; and executing the text detection model on the at least one inverted frame, resulting in at least one inverted text detection model output, wherein the identifying of the watermark is further based on the at least one inverted text detection model output.

The method of any preceding clause, further comprising: comparing, via the at least one processor, the watermark to known watermarks belonging to previously identified brands, resulting in a comparison; and removing, via the at least one processor, the video from the computer system based on the comparison.

A system comprising: at least one processor; and a non-tangible computer-readable storage medium having instructions stored which, when executed by the at least one processor, cause the at least one processor to perform operations comprising: receiving a video, the video comprising a plurality of frames; sampling frames from the plurality of frames, resulting in sampled frames and unsampled frames; averaging the sampled frames together, resulting in an averaged frame; executing a text detection model on the averaged frame, resulting in a text detection model output; and identifying, based on the text detection model output, a watermark found across the plurality of frames.

The system of any preceding clause, the non-tangible computer-readable storage medium having additional instructions stored which, when executed by the at least one processor, cause the at least one processor to perform operations comprising: generating using the averaged frame, at least one modified frame; and executing the text detection model on each cropped frame in the at least one modified frame, resulting in at least one modified text detection model output, wherein the identifying of the watermark is further based on the at least one modified text detection model output.

The system of any preceding clause, wherein the at least one modified frame comprises adding at least one pixel to the averaged frame, resulting in at least one of: a padded bottom, a padded top, a padded left, a padded right, a padded top-left, a padded top-right, a padded bottom-left, and a padded bottom-right.

The system of any preceding clause, wherein the at least one modified frame comprises removing at least one pixel from the averaged frame, resulting in at least one of: a cropped bottom, a cropped top, a cropped left, a cropped right, a cropped top-left, a cropped top-right, a cropped bottom-left, and a cropped bottom-right.

The system of any preceding clause, wherein the at least one modified frame comprises removing at least one pixel from a first side of the averaged frame and adding at least one pixel to a second side of the averaged frame.

The system of any preceding clause, the non-tangible computer-readable storage medium having additional instructions stored which, when executed by the at least one processor, cause the at least one processor to perform operations: generating, using the averaged frame, at least one inverted frame; and executing the text detection model on the at least one inverted frame, resulting in at least one inverted text detection model output, wherein the identifying of the watermark is further based on the at least one inverted text detection model output.

The system of any preceding clause, the non-tangible computer-readable storage medium having additional instructions stored which, when executed by the at least one processor, cause the at least one processor to perform operations: comparing the watermark to known watermarks belonging to previously identified brands, resulting in a comparison; and removing the video from the system based on the comparison.

A non-tangible computer-readable storage medium having instructions stored which, when executed by at least one processor, cause the at least one processor to perform operations comprising: receiving a video, the video comprising a plurality of frames; sampling frames from the plurality of frames, resulting in sampled frames and unsampled frames; averaging the sampled frames together, resulting in an averaged frame; executing a text detection model on the averaged frame, resulting in a text detection model output; and identifying, based on the text detection model output, a watermark found across the plurality of frames.

The non-tangible computer-readable storage medium of any preceding clause, having additional instructions stored which, when executed by the at least one processor, cause the at least one processor to perform operations comprising: generating using the averaged frame, at least one modified frame; and executing the text detection model on each cropped frame in the at least one modified frame, resulting in at least one modified text detection model output, wherein the identifying of the watermark is further based on the at least one modified text detection model output.

The non-tangible computer-readable storage medium of any preceding clause, wherein the at least one modified frame comprises adding at least one pixel to the averaged frame, resulting in at least one of: a padded bottom, a padded top, a padded left, a padded right, a padded top-left, a padded top-right, a padded bottom-left, and a padded bottom-right.

The non-tangible computer-readable storage medium of any preceding clause, wherein the at least one modified frame comprises removing at least one pixel from the averaged frame, resulting in at least one of: a cropped bottom, a cropped top, a cropped left, a cropped right, a cropped top-left, a cropped top-right, a cropped bottom-left, and a cropped bottom-right.

The non-tangible computer-readable storage medium of any preceding clause, wherein the at least one modified frame comprises removing at least one pixel from a first side of the averaged frame and adding at least one pixel to a second side of the averaged frame.

The non-tangible computer-readable storage medium of any preceding clause, having additional instructions stored which, when executed by the at least one processor, cause the at least one processor to perform operations: generating, using the averaged frame, at least one inverted frame; and executing the text detection model on the at least one inverted frame, resulting in at least one inverted text detection model output, wherein the identifying of the watermark is further based on the at least one inverted text detection model output.

We claim:

1. A method comprising:
receiving, at a computer system, a video, the video comprising a plurality of frames;
sampling frames from the plurality of frames via at least one processor, resulting in sampled frames and unsampled frames;
averaging, via the at least one processor, the sampled frames together, resulting in an averaged frame;
executing, via the at least one processor, a text detection model on the averaged frame, resulting in a text detection model output; and
identifying, via the at least one processor based on the text detection model output, a watermark found across the plurality of frames.

2. The method of claim 1, further comprising:
generating, via the at least one processor using the averaged frame, at least one modified frame; and
executing, via the at least one processor, the text detection model on each cropped frame in the at least one modified frame, resulting in at least one modified text detection model output,
wherein the identifying of the watermark is further based on the at least one modified text detection model output.

3. The method of claim 2, wherein the at least one modified frame comprises adding at least one pixel to the averaged frame, resulting in at least one of: a padded bottom, a padded top, a padded left, a padded right, a padded top-left, a padded top-right, a padded bottom-left, and a padded bottom-right.

4. The method of claim 2, wherein the at least one modified frame comprises removing at least one pixel from the averaged frame, resulting in at least one of: a cropped bottom, a cropped top, a cropped left, a cropped right, a cropped top-left, a cropped top-right, a cropped bottom-left, and a cropped bottom-right.

5. The method of claim 2, wherein the at least one modified frame comprises removing at least one pixel from a first side of the averaged frame and adding at least one pixel to a second side of the averaged frame.

6. The method of claim 1, further comprising:
generating, via the at least one processor using the averaged frame, at least one inverted frame; and
executing the text detection model on the at least one inverted frame, resulting in at least one inverted text detection model output,
wherein the identifying of the watermark is further based on the at least one inverted text detection model output.

7. The method of claim 1, further comprising:
comparing, via the at least one processor, the watermark to known watermarks belonging to previously identified brands, resulting in a comparison; and
removing, via the at least one processor, the video from the computer system based on the comparison.

8. A system comprising:
at least one processor; and
a non-tangible computer-readable storage medium having instructions stored which, when executed by the at least one processor, cause the at least one processor to perform operations comprising:
receiving a video, the video comprising a plurality of frames;
sampling frames from the plurality of frames, resulting in sampled frames and unsampled frames;
averaging the sampled frames together, resulting in an averaged frame;
executing a text detection model on the averaged frame, resulting in a text detection model output; and
identifying, based on the text detection model output, a watermark found across the plurality of frames.

9. The system of claim 8, the non-tangible computer-readable storage medium having additional instructions stored which, when executed by the at least one processor, cause the at least one processor to perform operations comprising:
generating using the averaged frame, at least one modified frame; and
executing the text detection model on each cropped frame in the at least one modified frame, resulting in at least one modified text detection model output,
wherein the identifying of the watermark is further based on the at least one modified text detection model output.

10. The system of claim 9, wherein the at least one modified frame comprises adding at least one pixel to the averaged frame, resulting in at least one of: a padded bottom, a padded top, a padded left, a padded right, a padded top-left, a padded top-right, a padded bottom-left, and a padded bottom-right.

11. The system of claim 9, wherein the at least one modified frame comprises removing at least one pixel from the averaged frame, resulting in at least one of: a cropped bottom, a cropped top, a cropped left, a cropped right, a cropped top-left, a cropped top-right, a cropped bottom-left, and a cropped bottom-right.

12. The system of claim 9, wherein the at least one modified frame comprises removing at least one pixel from a first side of the averaged frame and adding at least one pixel to a second side of the averaged frame.

13. The system of claim 8, the non-tangible computer-readable storage medium having additional instructions stored which, when executed by the at least one processor, cause the at least one processor to perform operations:
generating, using the averaged frame, at least one inverted frame; and
executing the text detection model on the at least one inverted frame, resulting in at least one inverted text detection model output,
wherein the identifying of the watermark is further based on the at least one inverted text detection model output.

14. The system of claim 8, the non-tangible computer-readable storage medium having additional instructions stored which, when executed by the at least one processor, cause the at least one processor to perform operations:
comparing the watermark to known watermarks belonging to previously identified brands, resulting in a comparison; and
removing the video from the system based on the comparison.

15. A non-tangible computer-readable storage medium having instructions stored which, when executed by at least one processor, cause the at least one processor to perform operations comprising:
receiving a video, the video comprising a plurality of frames;
sampling frames from the plurality of frames, resulting in sampled frames and unsampled frames;
averaging the sampled frames together, resulting in an averaged frame;
executing a text detection model on the averaged frame, resulting in a text detection model output; and
identifying, based on the text detection model output, a watermark found across the plurality of frames.

16. The non-tangible computer-readable storage medium of claim 15, having additional instructions stored which, when executed by the at least one processor, cause the at least one processor to perform operations comprising:
generating using the averaged frame, at least one modified frame; and
executing the text detection model on each cropped frame in the at least one modified frame, resulting in at least one modified text detection model output,
wherein the identifying of the watermark is further based on the at least one modified text detection model output.

17. The non-tangible computer-readable storage medium of claim 16, wherein the at least one modified frame comprises adding at least one pixel to the averaged frame, resulting in at least one of: a padded bottom, a padded top, a padded left, a padded right, a padded top-left, a padded top-right, a padded bottom-left, and a padded bottom-right.

18. The non-tangible computer-readable storage medium of claim 16, wherein the at least one modified frame comprises removing at least one pixel from the averaged frame, resulting in at least one of: a cropped bottom, a cropped top, a cropped left, a cropped right, a cropped top-left, a cropped top-right, a cropped bottom-left, and a cropped bottom-right.

19. The non-tangible computer-readable storage medium of claim 16, wherein the at least one modified frame comprises removing at least one pixel from a first side of the averaged frame and adding at least one pixel to a second side of the averaged frame.

20. The non-tangible computer-readable storage medium of claim 15, having additional instructions stored which, when executed by the at least one processor, cause the at least one processor to perform operations:
generating, using the averaged frame, at least one inverted frame; and
executing the text detection model on the at least one inverted frame, resulting in at least one inverted text detection model output,
wherein the identifying of the watermark is further based on the at least one inverted text detection model output.
